(19) United States
(12) Patent Application Publication
(10) Pub. No.: US 2003/0070027 A1
(43) Pub. Date: Apr. 10, 2003

(54) System for interconnecting peripheral host computer and data storage equipment having signal repeater means

(76) Inventor: Yiu-Keung Ng, Monterey Park, CA (US)

Correspondence Address: MORLAND C FISCHER, 2030 MAIN ST, SUITE 1050, IRVINE, CA, 92614

(21) Appl. No.: 09/972,301

(22) Filed: Oct. 9, 2001

(51) Int. Cl. G06F 13/38

(52) U.S. Cl. 710/305

(57) ABSTRACT

A data storage system having a plurality of computer peripheral equipment connected in electrical series with each other between a pair of peripheral host computers via peripheral cable segments. Each peripheral computer equipment includes a bank of data storage devices (e.g. disk drives) and a pair of signal repeaters. A first signal repeater is connected between bi-directional input and output peripheral cable connectors, and the second signal repeater is connected between the bank of data storage devices and each of the first repeater and the bi-directional output peripheral cable connector. By virtue of the foregoing, the data storage system of this invention is capable of enhanced reliability, flexibility and connectivity while effectively reducing signal delays, capacitive loading and transmission losses caused by transmission line effects, especially when the host computers and the computer peripheral equipment are positioned at distant locations relative to one another.

### BACKGROUND OF THE INVENTION

1. Field of the Invention

This invention relates to a data storage system which provides enhanced reliability, flexibility and connectivity for interconnecting peripheral host computers and peripheral data storage equipment while effectively reducing signal delays, capacitive loading and transmission losses of the system caused by the connection of signal cables, especially when the peripheral host computers and data storage equipment are positioned at distant locations.

2. Background Art

Referring initially to FIG. 1 of the drawings, a conventional system 1 is illustrated by which peripheral host equipment (e.g. a computer 3) is connected to a cluster of electronic equipment that is positioned at different locations (designated, for example, location A, location B and location C). The different locations A, B and C at which the electronic equipment is positioned can be close to or many feet away from each other or to the host computer 3. In fact, the different locations can be represented by different rooms. The cluster of electronic equipment at each of the locations A, B and C includes an electronic subsystem which, for example, may be a hard disk drive controller that is interconnected to a group of disk drives.

The host computer 3 in the conventional system 1 of FIG. 1 communicates with the electronic equipment at locations A, B and C by way of a series of peripheral cable segments 5, 6, 7, 8 and 9. Peripheral cable terminators, designated T, are connected to the first peripheral cable segment 5 at the host computer 3 and the last peripheral cable segment 9 at the location C where the electronic equipment is farthest from computer 3. The series of peripheral cable segments 5-9 are connected to the electronic subsystem of the electronic equipment at each location by respective pairs of cable connectors, designated C.

The operational difficulty with interconnecting the electronic equipment at multiple locations A, B and C to the host computer 3 in the system 1 as shown in FIG. 1 is that there are too many connection points used for connecting all of the electronic equipment to all of the peripheral cable segments 5-9 at the different locations along the entire length of the peripheral cable. As a consequence of the foregoing, capacitive loading on the peripheral bus is increased while transmission speed is undesirably decreased. What is more, long peripheral cable segments 5-9 increase the susceptibility of the system 1 to noise and the likelihood of signal degradation as a consequence of the transmission line effects (i.e. the inherent resistance, capacitance and inductance of a metallic cable) of the cable segments.

FIG. 2 of the drawings shows a first conventional attempt to solve the problems of capacitive loading, slow transmission speed and signal degradation that are all inherent in the system 1 of FIG. 1. As in FIG. 1, the system 10 of FIG. 2 includes a host computer 13 connected to a plurality of electronic equipment positioned at different locations (designated A, B, and C) which may be close together or in different rooms. The host computer 10 is interconnected with an electronic subsystem of the electronic equipment at each location A, B, and C by way of serially connected peripheral cable segments 15, 16, 17, 18 and 19. Peripheral cable terminators T are connected to the first peripheral cable segment 15 at the host computer 13 and to the last peripheral cable segment 19 at the electronic equipment at the farthest location C. The series of peripheral cable segments 15-19 are once again connected to the electronic subsystems of the respective electronic equipment at each location by pairs of peripheral cable connectors C1, C1 . . . C5, C5.

In an effort to overcome the operational difficulties described when referring to the system 1 of FIG. 1, the electronic equipment at each of the locations A, B and C is provided with a single signal repeater. In the example of FIG. 2, where a total of five electronic equipment is positioned at three locations, the system 10 will include a total of five signal repeaters designated R1, R2, R3, R4 and R5 that are all connected in series with one another and the host computer 13. As will be known to those skilled in the art, a repeater, such as that designed R1-R5 in FIG. 2, is adapted to amplify and filter the signal that is carried on the peripheral cable segments 15-19 to be supplied to the electronic subsystems of the respective electronic equipment. The repeaters R1-R5 also function as buffers and noise filters to clean the signals supplied to the electronic subsystems of the electronic equipment by the host computer 13 over peripheral cable segments 15-19.

In the case of FIG. 2, each of the repeaters R1-R5 of the five electronic equipment is connected in electrical parallel between a pair of peripheral cable terminators T1, T1 . . . T5, T5 to receive an input signal from a first peripheral cable segment 15-19 at a first of the pair of peripheral cable terminators C1-C5. The output signal is supplied from each electronic equipment to an adjacent, series connected peripheral cable segment at the second of the pair of peripheral cable connectors C1-C5 via a peripheral bus 21, 22, 23, 24 and 25 that is connected at a common electrical junction with the repeater (e.g. R1), one of the pair of peripheral cable terminators (e.g. T1), and the electronic circuitry of the electronic equipment.

The advantage of using the signal amplifying and filtering features of repeaters R1-R5 for the electronic equipment at locations A, B, and C that are interconnected with each other and the host computer 13 by way of serially connected peripheral cable segments 15-19 of FIG. 2 is to isolate the electronic subsystems of the electronic equipment from some (but not all) external electrical interference. As previously described, a repeater R1-R5 is included internally within each electronic equipment at each of the locations A, B, and C. In particular, a single repeater is connected between one of the pair of peripheral cable connectors and the electronic subsystem of the electronic equipment at each location. By way of example, transmission noise applied to the electronic subsystem of the first electronic equipment over peripheral cable segment 15 will be intercepted by repeater R1, while transmission noise applied to the same electronic equipment over peripheral cable segment 16 and peripheral bus 21 will remain unaffected.

What is even more, the signal repeaters R1-R5 of the electronic equipment at the locations A, B, and C are connected to respective peripheral cable segments 15-19 so as to lie in electrical series with one another. Thus, potentially long cumulative signal transmission delays, especially in cases when there is a large number of electronic equipment, can be introduced to undesirably slow the operation of this system 10 FIG. 2.

An attempt to solve the aforementioned problems (i.e. only partial isolation of the electronic subsystems from external electrical interference and potentially long cumulative transmission delays) that are inherent in the system 10 of FIG. 2 is represented by the system 10′ of FIG. 3. In this case, the signal repeaters R1-R4 of the electronic equipment at the different locations A-D are connected to respective peripheral cable segments 15′-18′ so that the repeaters lie in electrical parallel with one another. Like the system 10 of FIG. 2, the repeaters R1-R4 of the system 10′ in FIG. 3 are integrated within their respective electronic equipment. One side of each repeater R1-R4 is connected to an electronic subsystem, and the other side is connected to each one of the pair of peripheral cable connectors.

Unlike the system 10, the repeaters R1-R4 of system 10′ effectively isolate the electronic subsystem of each electronic equipment from the external peripheral cable segments 15′-18′ so as to better reduce the transmission line effects that are caused by such external cable segments on the data storage devices of the electronic subsystems. This allows for an increased number of data storage devices connected within the same electronic subsystem of each electronic equipment. Moreover, since the repeaters R1-R4 are connected in electrical parallel, the data storage devices within the same electronic subsystem of each electronic equipment will experience a single repeater transmission delay.

Unfortunately, in the system of 10′ of FIG. 3, all of the parallel connected repeaters R1-R4 are transmission drops to the peripheral bus cable. The transmission line effects caused by the multi-drop connections of repeaters R1-R4 greatly reduces the total peripheral bus cable length so as to undesirably limit the physical spacing between the locations of the electronic equipment. In this same regard, in order to maintain high transmission speed and reliable data transmission on the peripheral bus cable, the total length of the cable is also limited. Consequently, the total number of electronic equipment that can be connected to the peripheral bus cable is correspondingly limited, whereby the maximum number of electronic subsystems (i.e. data storage devices) that can be interconnected with one another and to the host computer 13′ within the entire system 10′ is minimized.

### SUMMARY OF THE INVENTION

A peripheral computer interconnect system is disclosed by which clusters of computer data storage devices (e.g. computer disk drives, or the like) that are housed within computer peripheral equipment positioned at different locations can be interconnected to communicate and transfer data with one another and with at least one peripheral host computer. The system advantageously provides enhanced reliability, flexibility and connectivity for interconnecting the peripheral data storage devices to each other and to the peripheral host computers while reducing the effect of signal delays, capacitive loading and transmission loses relative to conventional computer interconnect systems.

The interconnect system of this invention includes a plurality of computer peripheral equipment, each of which having a backpanel and a peripheral bus repeater module board that are detachably connected together by means of plug-in connectors. The backpanel of each computer peripheral equipment carries a string of disk drives that are coupled to a peripheral device bus signal path. The repeater module board carries a pair of signal repeaters. A first of the pair of signal repeaters is connected between first and second bi-directional peripheral cable connectors by way of first and second peripheral buses. The first repeater amplifies and filters the external signals that are carried on the first and second peripheral buses between the bi-directional peripheral cable connectors. The second signal repeater is connected to the bank of disk drives of the backpanel via a third peripheral bus. The second repeater amplifies and filters the internal signals to and from the bank of disk drives via the peripheral device signal path of the backpanel to which the disk drives are tied. The second repeater also isolates the bank of disk drives from the environment and from the possibility of electrostatic interference.

A plurality of the above-identified computer peripheral equipment at a first location are daisy chained together by means of multi-drop connections to respective peripheral bus cable segments. Other computer peripheral equipment at a different location is connected between one of the host computers and the plurality of computer peripheral equipment at the first location by means of point-to-point connections with respective peripheral bus cable segments. By virtue of the foregoing, relatively large peripheral bus cable segments can be used to interconnect the host computers and the computer peripheral equipment over long distances so that data can be transferred anywhere in the system while experiencing a time transfer delay of no longer than four times the delay introduced by one of the first or second signal repeaters of each computer peripheral equipment.

### BRIEF DESCRIPTION OF THE DRAWINGS

FIG. 1 shows a data storage interconnect system by which a host computer is interconnected to clusters of electronic equipment at different locations;

FIG. 2 shows a first conventional attempt to overcome the loading, speed, noise and timing problems that are associated with the host computer data storage interconnect system of FIG. 1;

FIG. 3 shows another conventional attempt to solve the loading, speed, noise and timing problems that are associated with the host computer data storage interconnect system of FIG. 1;

FIG. 4 is a block diagram to illustrate computer peripheral data storage equipment that is adapted to overcome the loading, speed, noise and timing problems caused by the transmission line effects of the metallic cable segments that are associated with the conventional host computer interconnect systems of FIGS. 1-3;

FIG. 5 shows the preferred implementation of the computer peripheral data storage equipment of FIG. 4;

FIG. 6 shows a first peripheral computer interconnect system for interconnecting a plurality of the computer peripheral data storage equipment shown in FIG. 5 with each other and with a pair of peripheral host computers; and

FIG. 7 shows an alternate peripheral computer interconnect system.

### DETAILED DESCRIPTION

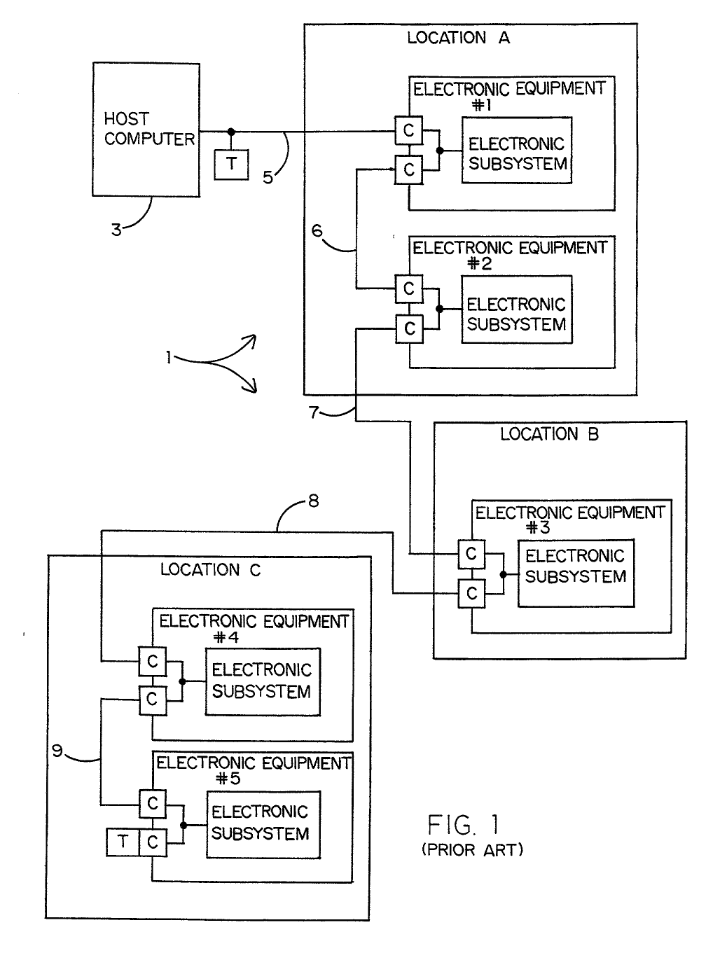

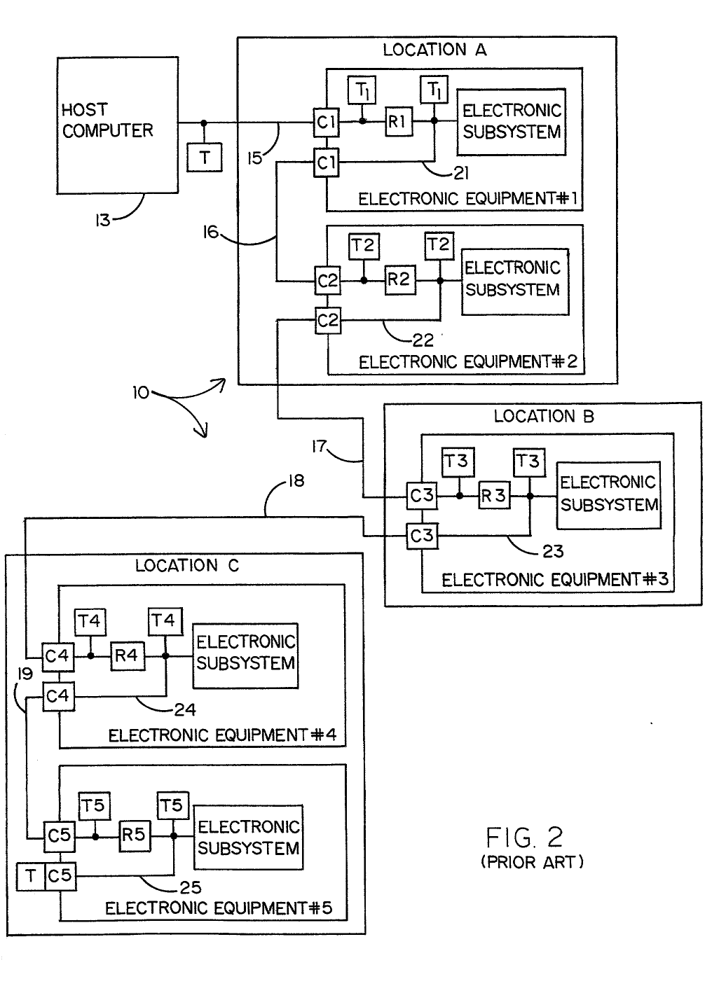

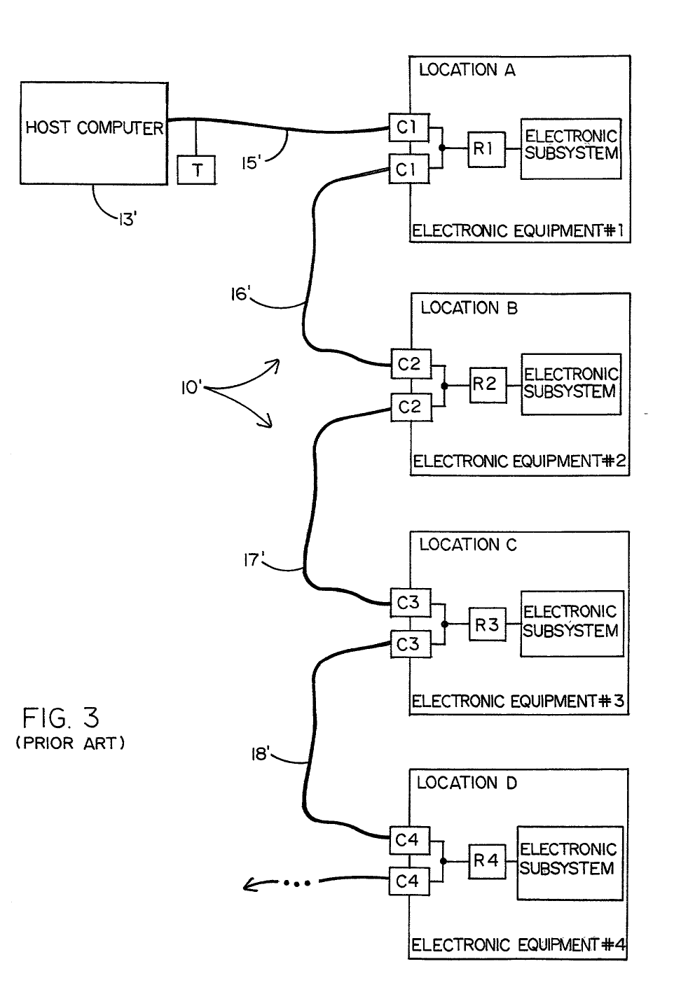

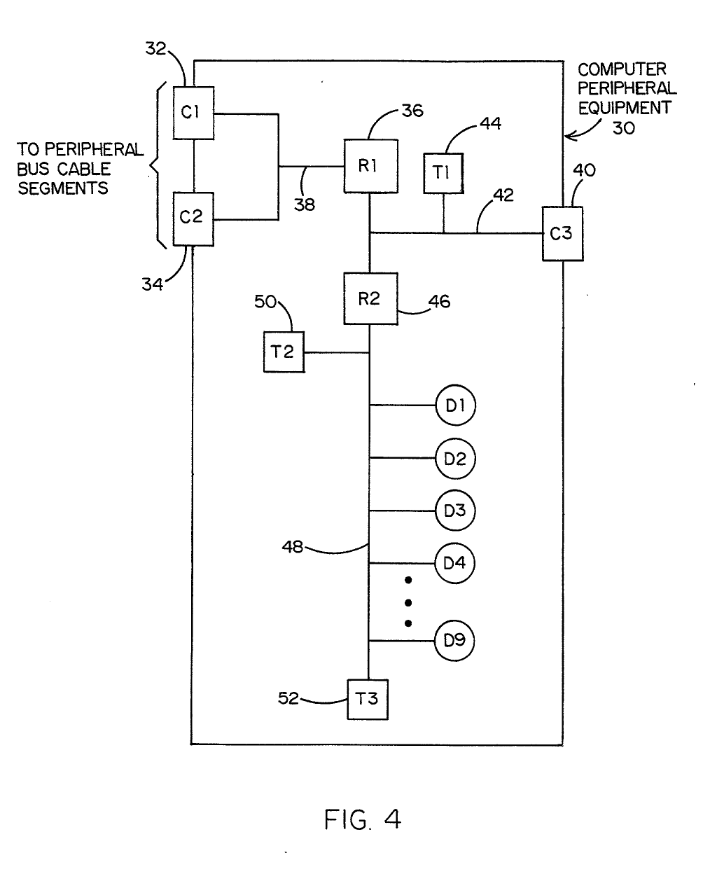

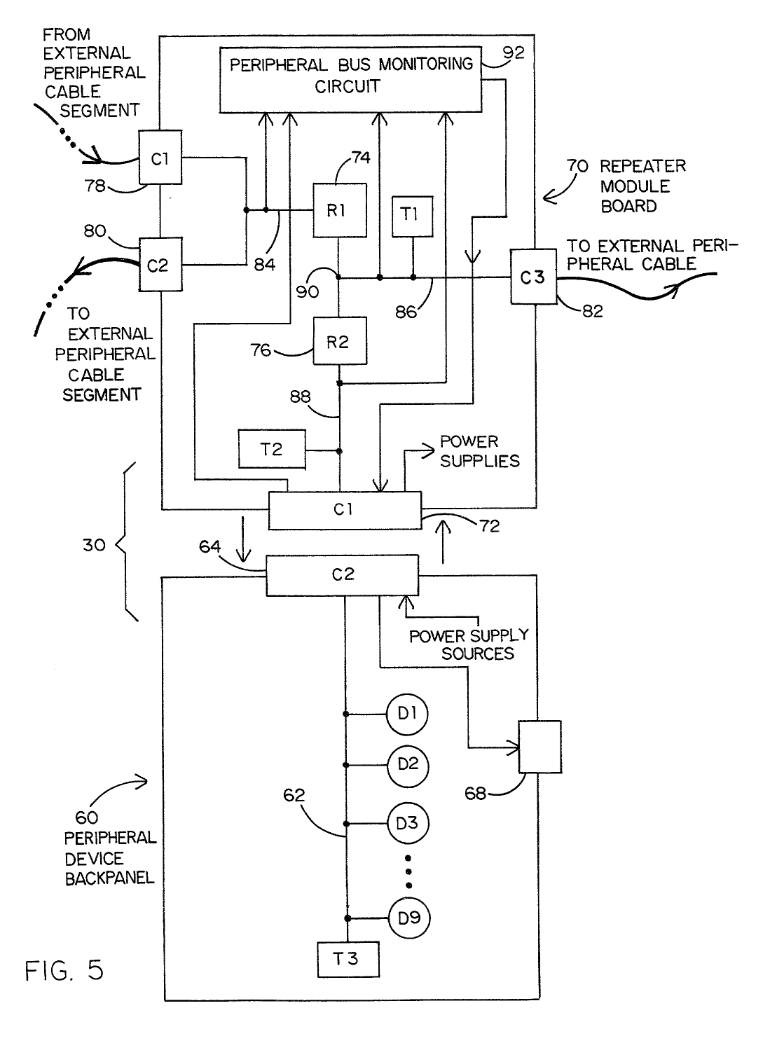

In accordance with the present improvements, FIG. 4 of the drawing shows a block diagram for implementing computer peripheral (e.g. data storage) equipment 30 that is adapted to overcome the loading, speed, noise and timing problems caused by the transmission line effects of metallic cable segments that are associated with the conventional computer interconnect systems 1, 10 and 10′ of FIGS. 1-3. Peripheral equipment 30 includes a bank of computer peripheral devices and control circuitry to be interfaced with a host peripheral computer in the manner to be disclosed in greater detail when referring to FIG. 5. By way of example only, the computer peripheral devices that are internal to the peripheral equipment 30 of FIG. 4 are any suitable number (e.g. nine) of computer disk drives D1 . . . D9. However, the peripheral equipment 30 may include other peripheral data storage devices, such as CD ROM drives, and the like.

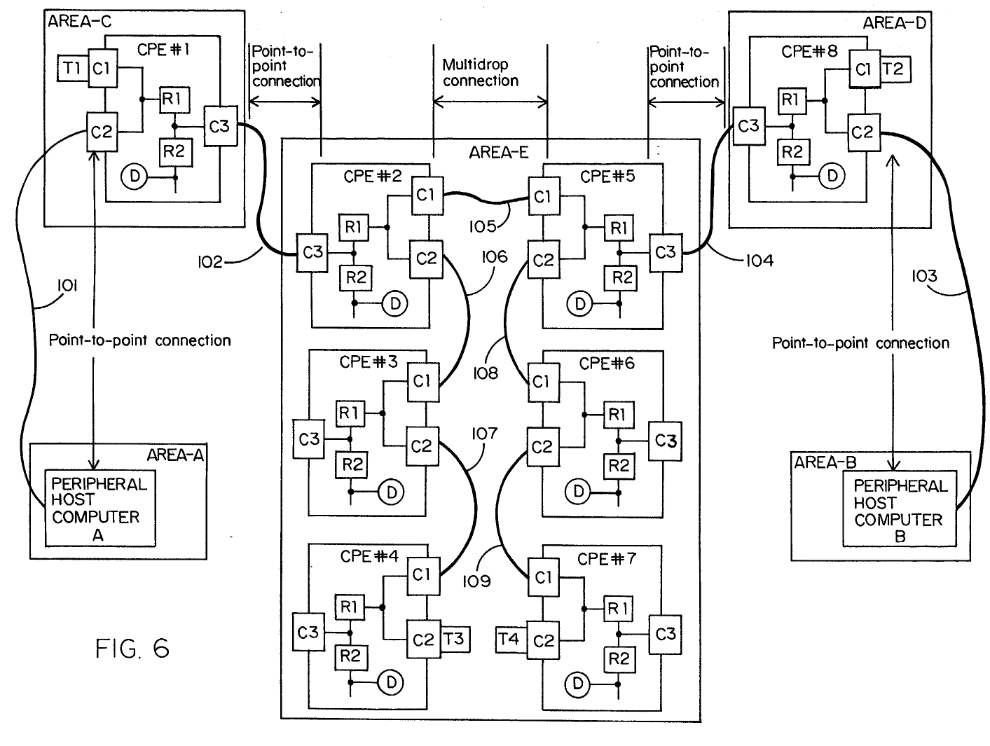

Peripheral equipment 30 includes a pair of bi-directional external peripheral cable connectors 32 and 34 that enable a plurality of computer peripheral equipment to be daisy chained together (best shown in FIG. 6). The peripheral cable connectors 32 and 34 are coupled to a first signal repeater 36 via a first peripheral bus 38. The first signal repeater 36 is connected to a bi-directional peripheral cable connector 40 via a second peripheral bus 42 which enables a point-to-point connection with a corresponding connector from computer peripheral equipment that is positioned at another location (also best shown in FIG. 6). A first peripheral bus terminator 44 is connected to the peripheral bus 42.

To achieve the advantage of this invention, a second signal repeater 46 is connected via a third peripheral bus 48 to each of the plurality of computer peripheral devices (e.g. disk drives D1-D9). The pair of repeaters 36 and 46 are connected together at a common electrical junction with the bi-directional peripheral bus connector 40 via the second peripheral bus 42. A second peripheral bus terminator 50 is connected at the interface of the signal repeater 46 with the peripheral bus 48, and a third peripheral bus terminator 52 is connected at the end of the peripheral bus 48.

Accordingly, it may be appreciated that the first repeater 36 of peripheral equipment 30 amplifies and filters bi-directional input and output signals that are carried back and forth between peripheral cable connectors 32 and 34 and peripheral cable connector 40. The presence of repeater 36 advantageously permits a relatively large number of peripheral cable segments to be used to serially interconnect a correspondingly large number of computer peripheral equipment, like that designated 30 (best shown in FIG. 6). The second repeater 46 isolates the plurality of disk drives D1-D9 from the outside environment. Moreover, repeater 46 also amplifies and filters the internal signals that are carried back and forth from the disk drives D1-D9 over the third peripheral bus 48. By way of example, each of the pair of signal repeaters 36 and 46 of computer peripheral equipment 30 in FIG. 4 is a commercially available SCSI bus expander device manufactured by Initio Corporation as Part No. INIC-525.

FIG. 5 of the drawings shows the preferred implementation of the computer peripheral (i.e. data storage) equipment 30 of FIG. 4. Peripheral equipment 30 includes a backpanel 60 at which a plurality of computer peripheral data storage devices (in this case, disk drives D1-D9) are located. The disk drives D1-D9 are coupled to a peripheral device bus signal path 62 which runs between a backpanel plug-in connector 64 and a terminator T3. The back panel 60 also includes an output connector 68 that is interfaced with the plug-in connector 64 to receive data storage equipment status signals for transmission to a user interface board (not shown) of the peripheral equipment 30.

Peripheral equipment 30 has a triple port peripheral bus repeater module board 70 to be detachably connected to the backpanel 60. The repeater module board 70 has a plug-in connector 72 (i.e. a first of the three ports of board 70) that is complementary to the plug-in connector 64 of backpanel 60, such that the plug-in connectors 72 and 64 can be mated to and detached from one another when it is necessary to repair or replace the repeater module board 70.

The advantages of this invention are achieved in the manner previously disclosed when referring to FIG. 4 by locating a pair of signal repeaters 74 and 76 on the triple port peripheral bus repeater module board 70. A first of the pair of repeaters 74 is coupled between a pair of bi-directional peripheral cable connectors 78 and 80 (i.e. the second port of board 70) and a bi-directional peripheral cable connector 82 (i.e. the third of the three ports of board 70) by way of peripheral buses 84 and 86. Repeater 74 amplifies and filters external signals that are carried back and forth on the buses 84 and 86 between peripheral cable connectors 78 and 80 and peripheral cable connector 82. The second of the pair of repeaters 76 is coupled at one end thereof to the plug-in connector 72 via peripheral device bus 88. The opposite end of repeater 76 is connected to a common electrical junction 90 with the first repeater 74 and the output peripheral cable connector 82. Repeater 76 isolates the string of disk drives D1-D9 that is tied to the peripheral device bus signal path 62 from the environment. Repeater 76 also amplifies and filters the internal signals that are carried back and forth to and from the disk drives D1-D9 via signal path 62.

The repeater module board 70 of peripheral equipment 30 also includes a peripheral bus monitoring circuit 92 which supplies data storage equipment status signals to the output connector 68 of backpanel 60. The monitoring circuit 90 of repeater module board 70 receives status signals from the peripheral buses 84, 86 and 88 of repeater module board 70 and the peripheral device signal path 62 of backpanel 60.

Turning now to FIG. 6 of the drawings, there is shown a system by which clusters of computer peripheral (e.g. data storage) equipment (designated CPE), like that shown in FIG. 5, can be interconnected with one another between a pair of peripheral host computers (designated host computer A and host computer B). In the example of FIG. 6, there is shown a cluster of eight computer peripheral equipment CPE1-CPE8. For purposes of illustration, the peripheral devices installed in each computer peripheral equipment is a bank of disk drives, designated D. The first peripheral host computer A is located at Area A, and the second peripheral host computer B is located at Area B. The first computer peripheral equipment CPE1 is located at Area C, the last computer peripheral CPE8 is located at Area D, and the remainder of the cluster of eight computer peripheral equipment CPE2-CPE7 are located at Area E.

The first computer peripheral equipment CPE1 at Area C is located far away from Areas A and E, such that computer peripheral equipment CPE1 is coupled between peripheral host computer A and computer peripheral equipment CPE2 by point-to-point connections to respective peripheral bus cable segments 101 and 102 that are characterized by only two loading points at the opposite ends of the cable segments which results in a low capacitive load and electrical noise reflections along the cable segments. That is, peripheral bus cable segment 101 is connected between host computer A and one of the pair of bi-directional peripheral cable connectors C2 (also designated 34 in FIG. 4) of computer peripheral equipment CPE1, and peripheral bus cable segment 102 is connected between the output peripheral cable connector C3 (also designated 40 in FIG. 4) of computer peripheral equipment CPE1 and the corresponding bi-directional peripheral cable connector C3 of computer peripheral equipment CPE2.

The last computer peripheral equipment CPE8 at Area D is located far away from Areas B and E such that computer peripheral equipment CPE8 is coupled between peripheral host computer B and computer peripheral equipment CPE5 by point-to-point connections to respective peripheral bus cable segments 103 and 104. All of the remaining computer peripheral equipment CPE2-CPE7 are located at the same Area E so as to be interconnected by relatively short multi-drop connections to peripheral bus cable segments 105-109. That is, the computer peripheral equipment CPE2-CPE7 are connected in electrical series by means of respective peripheral bus cable segments 105-109 running between peripheral cable connectors C1 and C2 of successive computer peripheral equipment in the manner shown in FIG. 6.

By virtue of the computer interconnect system shown in FIG. 6, the disk drives D of the computer peripheral equipment CPE1-CPE8 may communicate with one another and with host computers A and B with less capacitive loading and minimum signal delay on peripheral cable bus segments 101-109, whereby to reduce the chance for signal errors or failure. More particularly, the total number of repeaters R1, R2 that must be accessed when communicating with and transferring data between any two banks of disk drives D that are housed within any two computer peripheral equipment CPE1-CPE8 within the system is no more than four. Moreover, the total number of repeaters R1, R2 that must be accessed when communicating with and transferring data between either one of the peripheral host computers A or B and any bank of disk drives D housed within any of the computer peripheral equipment CPBE1-CPB8 within the system is also no more than four. In the data storage system of FIG. 6, if the bus signal delay caused by one of the repeaters R1, R2 is much greater than the delay introduced by the peripheral bus cable segments 101-109, then the cable delay can be ignored. Accordingly, the maximum bus signal delay encountered by the data storage system of FIG. 6 is essentially 4X, where X is the delay caused by a single repeater R1 or R2.

By way of example, in the case where the host computer A at Area A transfers data to the bank of disk drives D of computer peripheral equipment CPE8 at Area D, the total system data transmission delay is equal to the four individual delays introduced by CPE1(R1)+CPE2(R1)+CPE5(R1)+CPE8(R2). In the case where host computer B at Area B transfers data to the bank of disk drives D of computer peripheral equipment CPE4 at Area E, the total system delay is equal to the four individual delays introduced by CPE8(R1)+CPE5(R1)+CPE4(R1)+CPE4(R2). Lastly, in the case where a disk drive from the bank of disk drives of computer peripheral equipment CPE4 at Area E transfers data to a disk drive from the bank of disk drives of computer peripheral equipment CPE7 at the same Area E, the total system delay is still equal to the four individual delays introduced by CPE4(R2)+CPE4(R1)+CPE7(R1)+CPE7(R2).

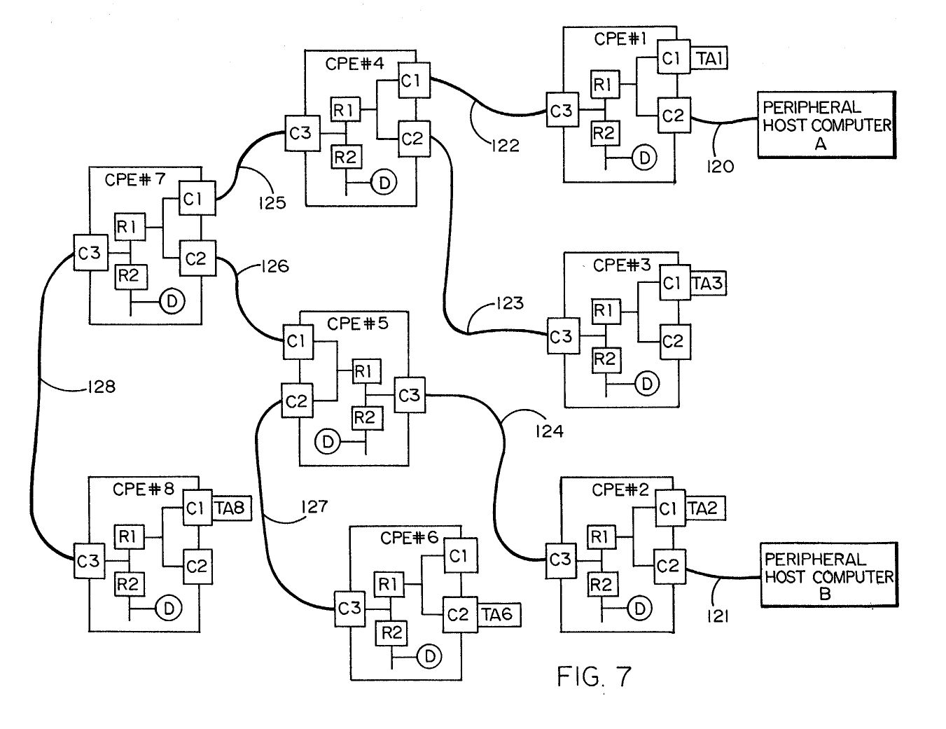

As an alternative to the system illustrated in FIG. 6, FIG. 7 of the drawings shows another system by which clusters of computer peripheral equipment (designated CPE) can be interconnected with one another between a pair of host computers A and B. Like FIG. 6, the system of FIG. 7 illustrates the flexibility of connecting a plurality of computer peripheral equipment using both point-to-point and multi-drop cable connections so as to result in reduced capacitance loading and minimum signal delay on the peripheral cable bus segments 120-128, whereby to reduce the chance for signal errors and failure.

By way of example, a first peripheral cable connector C1 of CPE7 is connected to peripheral cable connector C3 of an adjacent CPE4 via peripheral bus cable segment 125. Peripheral cable connector C2 of CPE7 is connected to peripheral cable connector C1 of adjacent CPE5 via peripheral bus cable segment 126. Lastly, peripheral cable connector C3 of CPE7 is connected to peripheral cable connector C3 of adjacent CPE8 via peripheral bus cable segment 128. Thus, it may be appreciated that CPE7 is efficiently connected to 3 adjacent computer peripheral equipment CPE4, CPE5 and CPE8.

In this same regard, peripheral cable connector C1 of CPE4 is connected to peripheral cable connector C3 of an adjacent CPE1 via peripheral bus cable segment 122. Peripheral cable connector C2 of CPE4 is connected to peripheral cable connector C3 of adjacent CPE3 via peripheral bus cable segment 123. Thus, it may be appreciated that CPE4 is also connected to adjacent computer peripheral equipment CPE1, CPE3 and CPE7.

By way of further example, peripheral cable connector C2 of CPE5 is connected to peripheral cable connector C3 of an adjacent CPB6 via peripheral bus cable segment 127. Peripheral cable connector C3 of CPE5 is connected to peripheral cable connector C3 of CPE2 via peripheral bus cable segment 124. Likewise, it may also be appreciated that CPB5 is connected to adjacent computer peripheral equipment CPB2, CPE6 and CPE7.

By way of one illustration, in the case where the host computer A transfers data to a bank of disk drives D of CPE8, the total system data transmission delay is equal to four individual delays introduced by CPE1(R1)+CPE4(R1)+CPE7(R1)+CPE8(R2). In a different illustration where a disk drive from the bank of disk drives of computer peripheral equipment CPE5 transfers data to a disk drive from the bank of disk drives of computer peripheral equipment CPE3, the total system delay is still equal to the four individual delays introduced by CPE5(R2)+CPE5(R1)+CPE4(R1)+CPE3(R2).

It may now be appreciated that at least eight or more computer peripheral equipment, each having a bank of data storage devices, may be interconnected in a data storage system like that shown in FIGS. 6 and 7 while reducing the total system delay to no more than four times the delay introduced by one of the signal repeaters R1 or R2. In addition, the flexibility of the connections between peripheral host computers A and B with the computer peripheral equipment CPE1-CPE8 is increased. By virtue of the foregoing, longer peripheral cable segments may now be used over greater distances without experiencing a data transfer delay between any two points in the system that is longer than four times the delay of a single repeater R1 or R2.

I claim:

1. A computer peripheral equipment interconnect system for interconnecting at least one host computer with a plurality of computer peripheral equipment by way of respective peripheral cable segments running therebetween, each computer peripheral equipment of said plurality of computer peripheral equipment including a bank of data storage devices and comprising:
first bi-directional peripheral cable connector means by which said computer peripheral equipment is adapted to be electrically connected with a second computer peripheral equipment of said plurality of computer peripheral equipment;
second bi-directional peripheral cable connector means by which said computer peripheral equipment is adapted to be connected to a third computer peripheral equipment of said plurality of computer peripheral equipment;
a first signal repeater connected between said first bi-directional peripheral cable connector means and said second bi-directional peripheral cable connector means to filter and amplify signals transmitted therebetween; and
a second signal repeater connected between said bank of data storage devices and each of said first signal repeater and said second bi-directional peripheral cable connector means to filter and amplify the signals transmitted to and from said bank of data storage devices and to isolate said bank of data storage devices from external interference.

2. The computer peripheral equipment interconnect system recited in claim 1, wherein the bank of data storage devices are located on a back panel and said first and second signal repeaters are located on a repeater board, said back panel and said repeater board being detachably connected to one another.

3. The computer peripheral equipment interconnect system recited in claim 2, wherein each of said back panel and said repeater board has a plug-in connector to be mated together, whereby said back panel and said repeater board are detachably connected to one another so that said bank of data storage devices on said back panel can transmit and receive data by way of said first and second signal repeaters on said repeater board.

4. The computer peripheral equipment interconnect system recited in claim 3, wherein said bank of data storage devices is a string of computer disk drives that are electrically connected to a peripheral data bus that is connected to the plug-in connector of said back panel.

5. The computer peripheral equipment interconnect system recited in claim 1, wherein said first bi-directional peripheral cable connector means includes a pair of cable connectors, each of said pair of cable connectors being connected to said first signal repeater, one of said pair of cable connectors being connected to a preceding one of said plurality of computer peripheral equipment by a first peripheral cable segment, and the other of said pair of cable connectors being connected to a succeeding one of said plurality of computer peripheral equipment by a second peripheral cable segment, whereby said computer peripheral equipment is connected in a serial daisy chain with the preceding and succeeding ones of said plurality of computer peripheral equipment.

6. The computer peripheral equipment interconnect system recited in claim 1, wherein said first and second signal repeaters of said plurality of peripheral equipment are interconnected with said peripheral cable segments so that the maximum signal delay to transfer data between the host computer and the bank of data storage devices of any one of said plurality of computer peripheral equipment is no greater than four times the signal delay introduced by either one of said first or second signal repeaters.

7. The computer peripheral equipment interconnect system recited in claim 1, wherein said first and second signal repeaters of said plurality of peripheral equipment are interconnected with said peripheral cable segments so that the maximum signal delay to transfer data between the bank of data storage devices of any one of said plurality of computer peripheral equipment and the bank of data storage devices of any other of said plurality of computer peripheral equipment is no greater than four times the signal delay introduced by either one of said first or second signal repeaters.

8. The computer peripheral equipment interconnect system recited in claim 1, further comprising a first host computer connected to the first of said plurality of computer peripheral equipment, and a second host computer connected to the last of said plurality of computer peripheral equipment.

9. The computer peripheral equipment interconnect system recited in claim 1, wherein the first bi-directional peripheral cable connector means of said computer peripheral equipment is connected to the first bi-directional peripheral cable connector means of the second of said plurality of computer peripheral equipment by way of a first peripheral cable segment, and the second bi-directional peripheral cable connector means of said computer peripheral equipment is connected to the second bi-directional peripheral cable connector means of the third of said plurality of computer peripheral equipment by way of a second peripheral cable segment.
